(19) United States
(12) Patent Application Publication
(10) Pub. No.: US 2025/0116577 A1
(43) Pub. Date: Apr. 10, 2025

(54) RECIRCULATION SYSTEM FOR AEROSOL COLLECTORS USING LIQUID COLLECTION BUFFER

(71) Applicant: GEORGIA TECH RESEARCH CORPORATION, Atlanta, GA (US)

(72) Inventors: Michael L. FARRELL, Atlanta, GA (US); David HU, Rockville, MD (US); Soohwan KIM, Atlanta, GA (US); Seth Adam STEWART, Louviers, CO (US)

(21) Appl. No.: 18/836,286

(22) PCT Filed: Feb. 10, 2023
(86) PCT No.: PCT/US2023/012819

§ 371 Date: Aug. 6, 2024

Related U.S. Application Data
(60) Provisional application No. 63/308,641, filed on Feb. 10, 2022.

(51) Int. Cl. G01N 1/22; B04C 3/06; B04C 9/00; B04C 11/00

(52) U.S. Cl. CPC G01N 1/2205; B04C 3/06; B04C 9/00; B04C 11/00; G01N 1/2211; B04C 2009/004; B04C 2009/005; G01N 2001/2223

(57) ABSTRACT

An exemplary active recirculation system and method for aerosol collection are disclosed that employ recirculation via one or more active pumps (e.g., peristaltic pumps) to continuously circulate a collection buffer within an aerosol collection frontend to improve the collection efficiency. In using less fluid volume, the exemplary active recirculation system and method increase the concentration of the target particle. A high concentration of particles may be advantageous when detecting pathogens downstream of collection. The aerosol collection frontend connects to a collection reservoir. During a collection cycle, a pump draws the fluid from the collection reservoir and pumps the collected fluid back into the collection front end at a set flow rate.

### RELATED APPLICATION

This PCT application claims priority to, and the benefit of, U.S. Provisional Patent Application No. 63/308,641, filed Feb. 10, 2022, entitled “RECIRCULATION SYSTEM FOR AEROSOL COLLECTORS USING LIQUID COLLECTION BUFFER,” which is incorporated by reference herein in its entirety.

### GOVERNMENT LICENSE RIGHTS

This invention was made with government support under award no. HR00112190060 awarded by the Defense Advanced Research Projects Agency. The government has certain rights in the invention.

### BACKGROUND

There is interest in the collection and analysis of aerosol particles for environmental air sampling, counter-terrorism, epidemiology, medicine, and agriculture, among various applications. These applications typically involve the monitoring or collection of airborne plant, animal, or human pathogens.

In the wake of the COVID-19 pandemic, there is greater interest in identifying airborne pathogens in real time. The efficacy of these devices has been evaluated in hospital settings (“Viable SARS-COV-2 in the air of a hospital room with COVID-19 patients”, Lednicky et al.), and the monitoring of airborne pathogens could become commonplace in hospitals, government buildings, and military complexes. Monitoring of aerosolized pathogens is of particular interest to agriculture, where the spread of disease in livestock could have devastating consequences.

Current aerosol collection system, e.g., wetted wall air sampler, employs a cyclone that pulls in air, spins it, and as it spins it, centrifugal forces pull out the particles into a solution. The current system generates liquid that is directly proportionate to the amount of processed air. Thus, the more air that is collected, the more solution there is to analyze.

There is a benefit to improving the collection and analysis of aerosol particles.

### SUMMARY

An exemplary active recirculation system and method for aerosol collection are disclosed that employ recirculation via one or more active pumps (e.g., peristaltic pumps) to continuously circulate a collection buffer within an aerosol collection frontend to improve the collection efficiency. In using less fluid volume, the exemplary active recirculation system and method increase the concentration of the target particle. A high concentration of particles may be advantageous when detecting pathogens downstream of collection. The aerosol collection frontend connects to a collection reservoir. During a collection cycle, a pump draws the fluid from the collection reservoir and pumps the collected fluid back into the collection front end at a set flow rate.

In an aspect, a system is disclosed comprising: an aerosol collection frontend configured to capture, in a hydrosol (e.g., buffer+captured aerosols and/or particles), aerosols and/or particles from a continuous moving volume of air (e.g., continuous stream of air) through an input nozzle; and a recirculation assembly operatively coupled to the aerosol collection frontend to recirculate the hydrosol collected from the frontend and a recirculation volume of hydrosol to increase the concentration of the captured aerosols and/or particles in the captured hydrosol for sampling thereof, the recirculation assembly including a collection reservoir configured to connect to the aerossol collection frontend to collect the hydrosol, the collection reservoir maintaining a part of the recirculation volume of hydrosol, and a first pump operatively connected to the collection reservoir to move the recirculation volume of hydrosol from the collection reservoir to a recirculation input of the acrosol collection frontend.

In some implementations, the system further includes a buffer replenishment reservoir and a second pump operatively connected to the buffer replenishment reservoir to move replacement clean hydrosol from the buffer replenishment reservoir to the collection reservoir.

In some implementations, the system further includes a filter, and the aerosols and/or particles are less than 10 μm.

In some implementations, the system further includes a sampling output port or sensor for analysis of the captured aerosols and/or particles in the captured hydrosol.

In some implementations, the system further includes a sensor module coupled to the sampling output port or sensor. The sensor module is configured to analyze the captured aerosols and/or particles in the captured hydrosol to detect a target pathogen or particle (e.g., COVID-19, bacterial pathogens, airborne pollutants, etc.).

In some implementations, the sensor module is modular such that the sensor module may be replaced with a different sensor module configured to analyze and detect a different target pathogen or particle.

In some implementations, the aerosol collection frontend comprises a wet cyclone assembly, a wetted wall cyclone assembly, or a condensation-based collection assembly.

In some implementations, the wet cyclone assembly or the wetted wall cyclone assembly includes a fluid atomizer, or a mixer configured to mix the hydrosol with the continuous moving volume of air and a skimmer configured to collect the captured hydrosol and guide it towards the recirculation assembly.

In some implementations, the hydrosol includes a buffered saline solution (e.g., phosphate-buffered saline).

In some implementations, the system further includes an H-bridge converter to operate the first pump of the recirculation assembly.

In some implementations, the system is configured to provide airflow of at least 18,000 L/min with a collection efficiency greater than 65%, and a concentration increase of at least 2×.

In some implementations, the system further includes a plurality of sensors connected to at least one of the aerosol collection frontend, the collection reservoir, the buffer replenishment reservoir, or any fluid conduit therebetween, wherein any one of the plurality of sensors is configured to sense pressure, humidity, temperature, or flow rate.

In some implementations, the system further includes a microcontroller in electrical communication with the plurality of sensors, the microcontroller configured to communicate with the H-bridge to control the converter to control the operation of the first pump or the second pump.

In another aspect, a method of capturing aerosols and/or particles from a continuously moving volume of air (e.g., a continuous stream of air) is disclosed, the method comprising: capturing, in a hydrosol (e.g., buffer+captured aerosols and/or particles), aerosols and/or particles from a continuous moving volume of air (e.g., a continuous stream of air) through an input nozzle of an aerosol collection frontend; and recirculating the hydrosol collected from the frontend and a recirculation volume of hydrosol to increase the concentration of the captured aerosols and/or particles in the captured hydrosol for sampling thereof, wherein the recirculating moves the recirculation volume of hydrosol from a collection reservoir to a recirculation input of the aerosol collection frontend.

In some implementations, the method further includes outputting, through a sampling output port, a sample volume of the captured aerosols and/or particles in the captured hydrosol.

In some implementations, the method further includes introducing a volume of replacement clean hydrosol from a buffer replenishment reservoir into the collection reservoir or the aerosol collection frontend to replace the output sample volume.

In some implementations, the method further includes reversing the flow direction of the hydrosol at the end of a sampling period to drain excess volumes of hydrosol in a fluid line back into the collection reservoir.

In some implementations, the method further includes: monitoring any one of pressure, temperature, humidity, or flow rate of the hydrosol or the air; relaying sensor data to a microcontroller; and adjusting the flow parameters of the aerosol collection frontend or the recirculating hydrosol based on the sensor data.

In some implementations, the capturing or recirculating steps are performed until: (i) a predetermined volume of the continuous moving volume of air has moved through the aerosol collection frontend; (ii) a predetermined period of time has passed since the capturing began; (iii) a predetermined period of time has passed since the recirculating began; (iv) a predetermined volume of the sample volume of the captured aerosols and/or particles in the captured hydrosol has been collected through the sampling output port; or (v) a predetermined volume of the replacement clean hydrosol has been introduced from the buffer replenishment reservoir into the collection reservoir or the aerosol collection frontend.

In some implementations, the method further includes analyzing a sample volume of the captured aerosols and/or particles in the captured hydrosol; and detecting the presence or absence of a target pathogen or particle (e.g., COVID-19, bacterial pathogens, airborne pollutants, etc.).

### BRIEF DESCRIPTION OF THE DRAWINGS

The skilled person in the art will understand that the drawings described below are for illustration purposes only.

FIG. 1 is a schematic diagram of an aerosol collection system, according to one implementation.

FIG. 2 is a flowchart showing an example method to capture and amplify concentration, in a hydrosol, aerosols, and/or particles from a continuously moving volume of air, according to an illustrative embodiment.

FIGS. 3A-3G show diagrams and example methods of operation of an active recirculation system for aerosol collectors, according to various implementations.

FIGS. 4A-4B shows images and models of an experimental wet cyclone system, according to one implementation.

FIGS. 4C shows a model of an experimental wet cyclone aerosol collection system and a corresponding computational fluid dynamics (CFD) graphic, according to one implementation.

FIG. 4D displays graphical information and experimental results for tests performed on an aerosol collection system, according to one implementation.

FIG. 5A displays graphical information for the efficiency of an aerosol collection system, according to one implementation.

FIG. 5B displays graphical information for an example aerosol collection system, according to one implementation.

FIG. 5C shows a diagram of an example fluidic system, according to one implementation.

FIG. 5D shows experimental results of purification and filtration, according to one implementations.

FIGS. 6A-6F show examples of aerosol collection systems, according to various implementations.

### DETAILED SPECIFICATION

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the nth reference in the list. All references cited and discussed in this specification are incorporated herein by reference in their entireties and to the same extent as if each reference was individually incorporated by reference.

### Example System

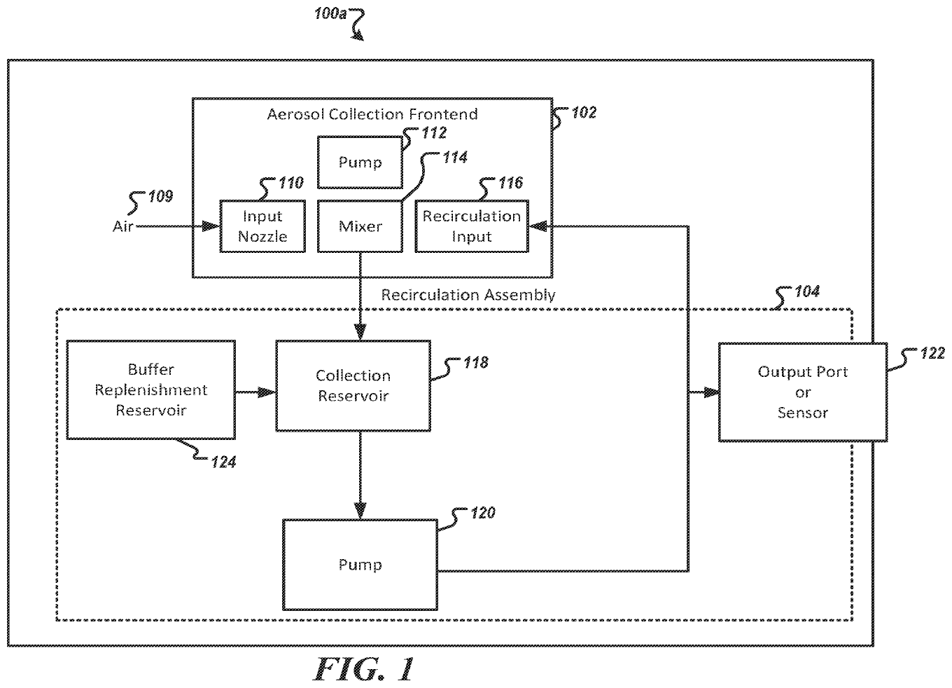

FIG. 1 is a schematic diagram of an aerosol collection system 100 (shown as 100a) configured to capture and amplify concentration in a hydrosol (e.g., buffer+captured aerosols and/or particles) of aerosols and/or particles from a continuous moving volume of air (e.g., a continuous stream of air) according to an illustrative embodiment. In the example of FIG. 1, the collection system 100a includes an aerosol collection frontend 102 and a recirculation assembly 104.

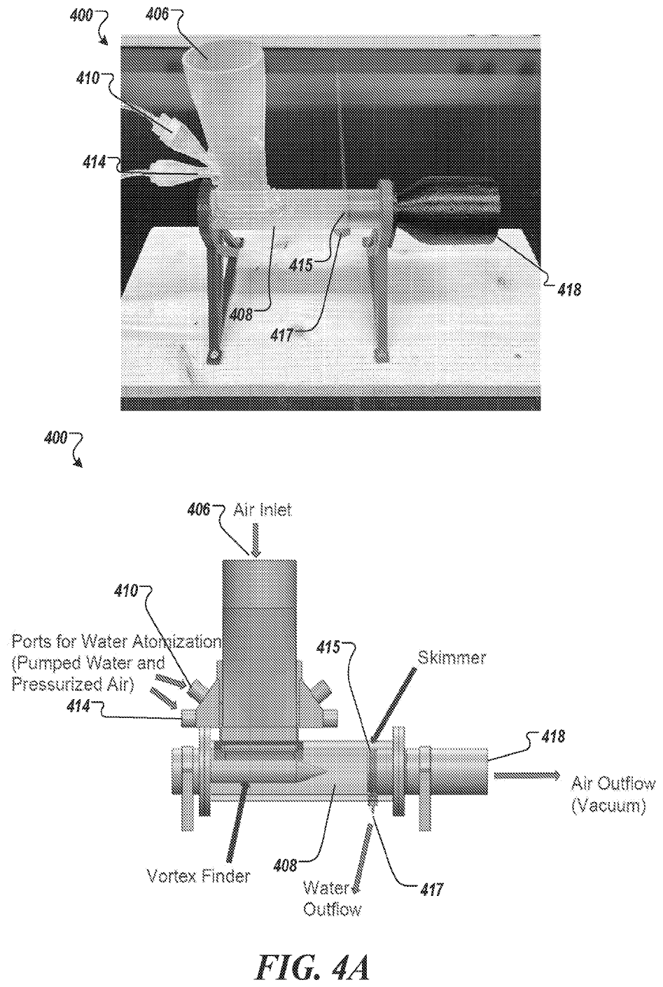

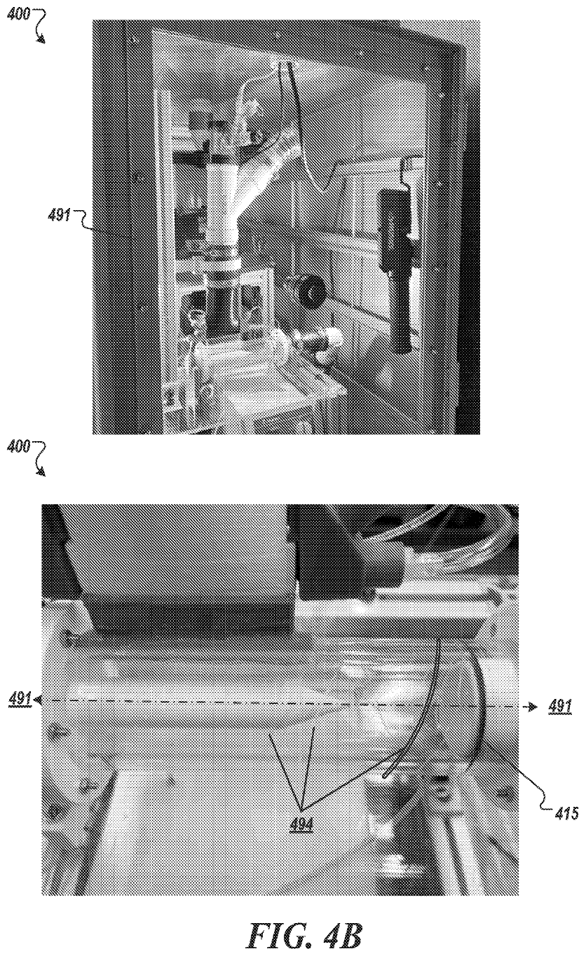

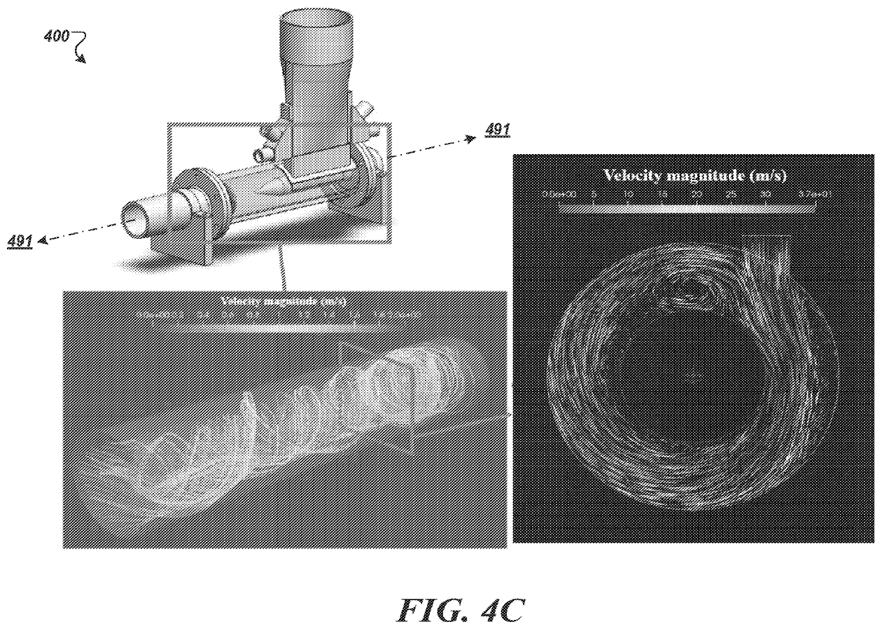

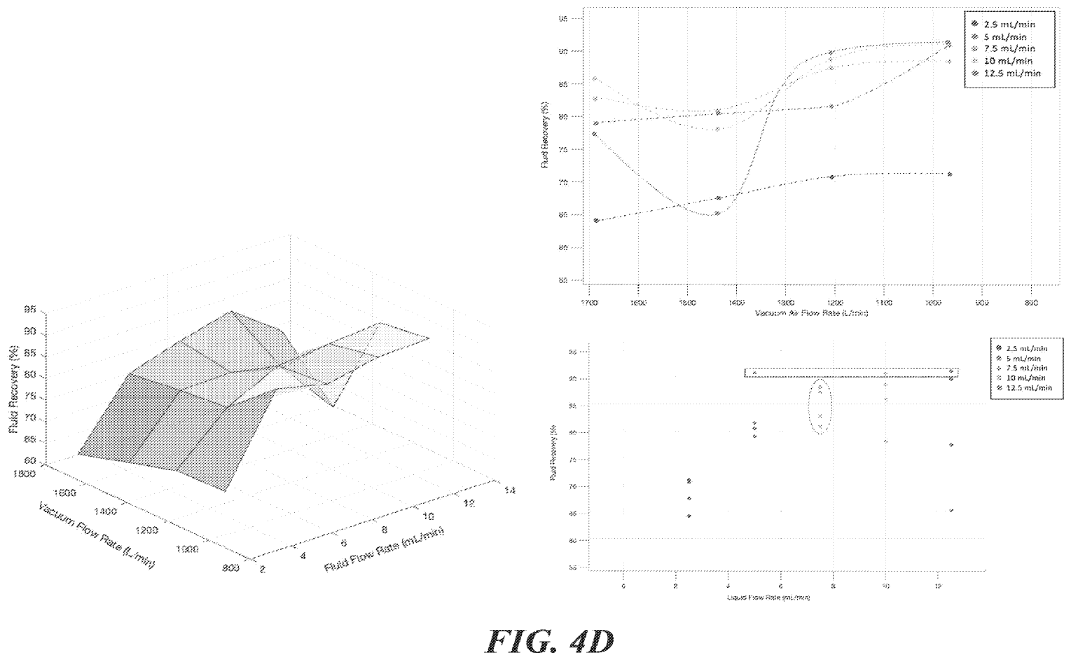

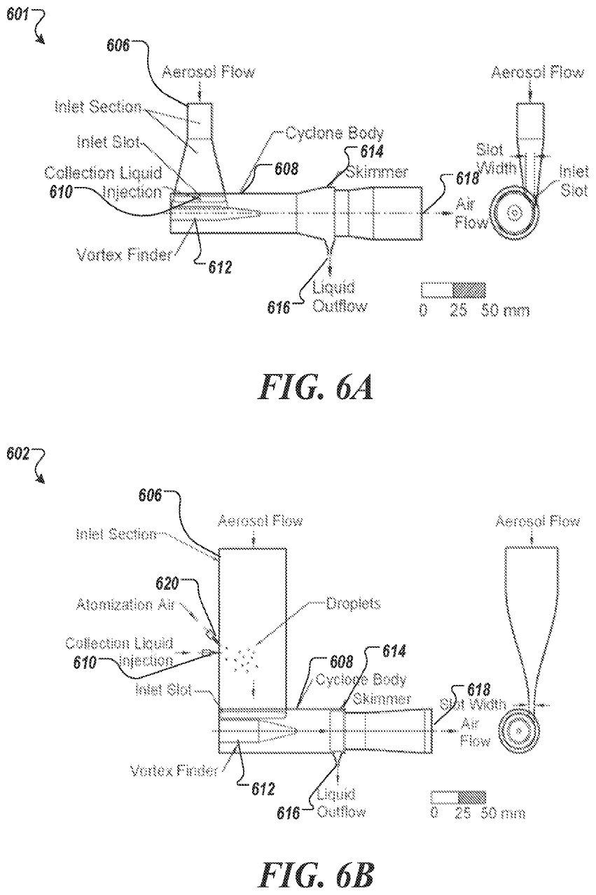

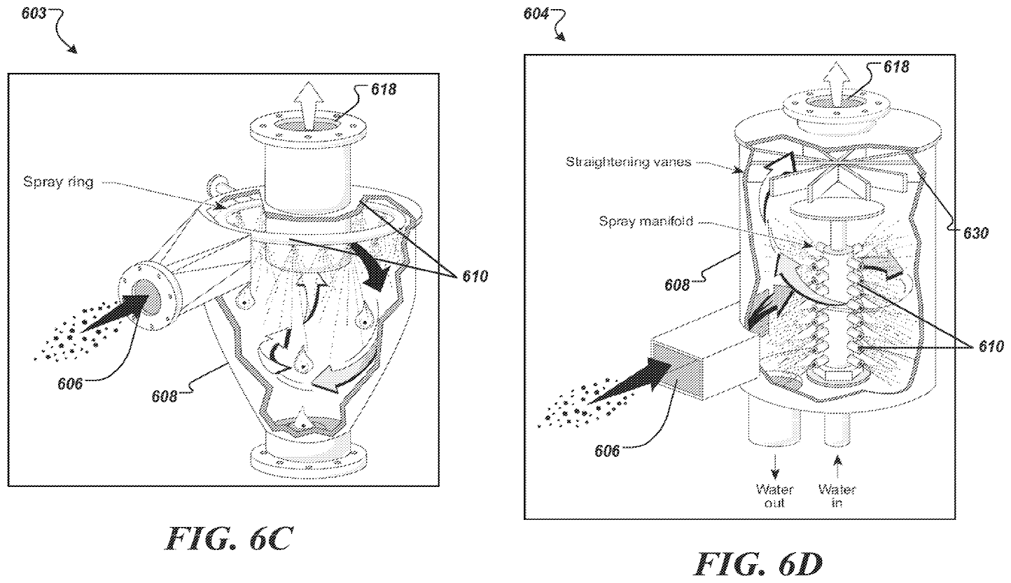

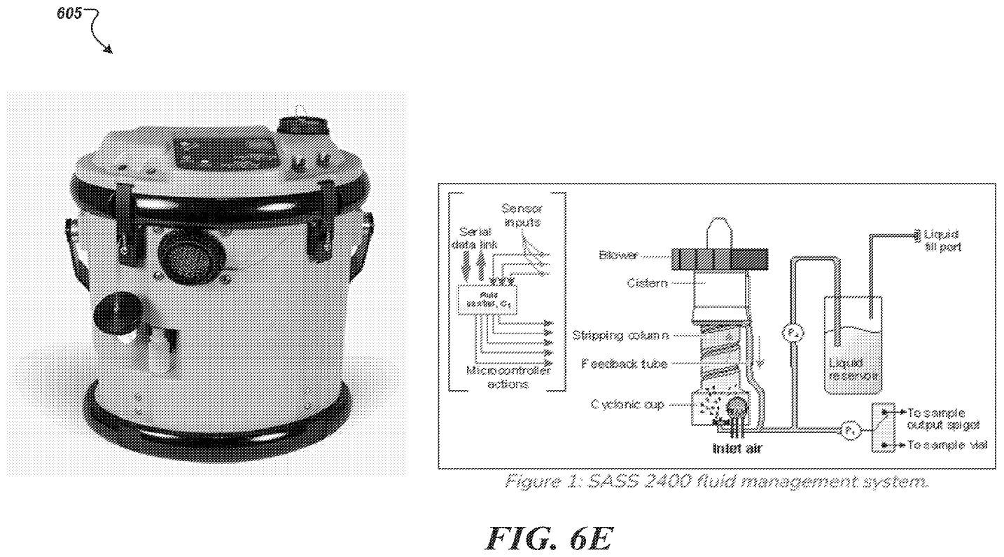

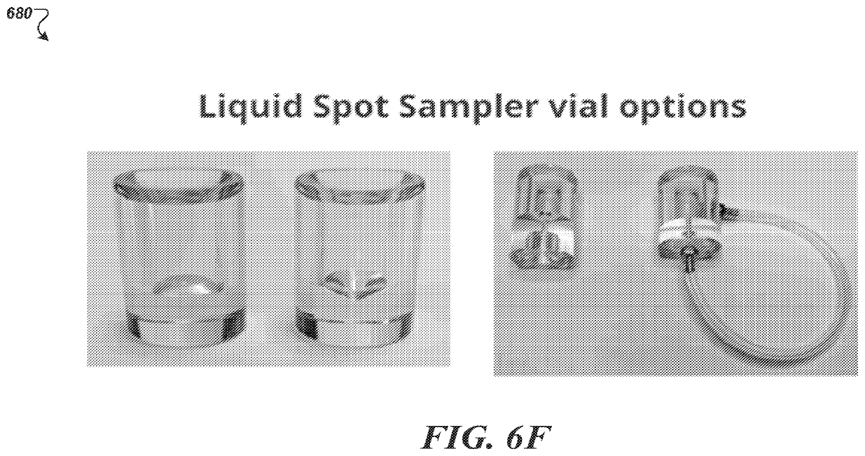

Aerosol collection frontend. The aerosol collection frontend 102 is configured to capture, in a hydrosol 106 (not shown—see fluid in FIG. 4A-4B), aerosols and/or particles 108 (not shown—see generally FIG. 6A-6D) from a continuous moving volume of air 109 (e.g., a continuous stream of air) through an input nozzle 110. The hydrosol 106 comprises a buffer and a part of the captured aerosol particles. Examples of buffers include a phosphate-buffered saline (PBS) solution and other saline solutions.

In the example shown in FIG. 1, the aerosol collection frontend 102 includes the input nozzle 110, a pump 112, a mixer 114, and a recirculation input 116.

Air 109 flows into the aerosol collection frontend 102 through the input nozzle 110. For example, air 109 may be pumped or vacuumed into an input nozzle 110 that is open to the environment of interest for sampling. The pumping or vacuuming may be performed by the pump 112 of the aerosol collection frontend 102. In some implementations, the pump 112 is a vacuum pump configured to pull the air into the input nozzle 110 and, through the aerosol collection frontend 102, back into the environment. In other implementations, the pump 112 may cause a fluid to flow into the aerosol collection frontend 102. In some implementations, there is a pump 112 each for moving the air 109 and the fluid.

The input nozzle 110 is in fluid communication with the mixer 114 and causes flowing air 109 to enter the mixer 114. The mixer 114 allows the air 109 and the fluid to mix within the aerosol collection frontend 102. In some implementations, the mixer 114 is a water atomization comprising compressed air introduced adjacent to the fluid input to break the fluid into small particles. This atomization/mixing process increases the over-surface area of the fluid within the mixer 114, which allows for greater mixing of the fluid and air 109. The greater mixing allows the fluid to collect a greater number, mass, or concentration of sample particles from the air 109.

In some implementations, the aerosol collection frontend 102 is a cyclone body configured to create a vortex of fluid flow and collect sample fluid therein, as described by specific examples throughout this specification.

Recirculation assembly. The recirculation assembly 104 includes a collection reservoir 118, a pump 120, an output port or sensor 122, and a buffer replenishment reservoir 124

The collection reservoir 118 is in fluid communication with the mixer 114 of the aerosol collection frontend 102 and configured to collect fluid from the mixer 114. In other words, while air 109 is pumped through the aerosol collection frontend 102, fluid is mixed with the air 109 to collect samples from the air. This sample fluid flows into the collection reservoir 118 of the recirculation assembly 104.

The pump 120 of the recirculation assembly 104 is configured to move fluid from the collection reservoir 118 out of the recirculation assembly 104 and back into the aerosol collection frontend 102 via the recirculation input 116. The recirculation input 116 then introduces the fluid into the mixer 114 to once again mix with and collect samples from the air 109 flowing through. This recirculation process continues until the sample fluid has collected an adequate amount or concentration of samples from the air 109. In some implementations, the recirculation process continues for a predetermined time until a predetermined volume of liquid has been recirculated or until a predetermined volume of air 109 has been pumped through the frontend 102.

At any time in the recirculation process, including once the sample fluid has reached a desired concentration, the output port or sensor 122 is configured to pump some fluid out of the recirculation assembly 104. The output port or sensor 122 may be a simple collection tube used to collect a sample of concentrated sample fluid. In some implementations, the output port or sensor 122 may also include a sensor module configured to detect a desired pathogen or airborne particle. In some implementations, the output port or sensor 122 can be exchanged for a different output port or sensor 122 configured for collecting a new sample fluid or detecting a different pathogen or airborne particle of interest.

As sample fluid is drawn out of the recirculation assembly 104, it may be replaced by the introduction of additional buffer fluid via the buffer replenishment reservoir 124. The buffer replenishment reservoir 124 is configured to pump additional fluid into the collection reservoir 118 to maintain a desired volume of liquid flowing between the recirculation assembly 104 and the aerosol collection frontend 102. In some implementations, the buffer replenishment reservoir 124 pumps an initial amount of fluid into the collection reservoir on startup of the system 100a.

As described above, the aerosol collection frontend 102 can include a variety of exemplary systems. Generally, they can be described as either cyclone-based systems or condensation-based systems. Examples of cyclone-based systems include wetted wall cyclones, traditional wet cyclones, or other commercial products.

### Example Wet Cyclone Aerosol Collection Front End #1

Examples of a wetted wall cyclone are shown in FIG. 6A and FIG. 6B from McFarland et al. (2020) [1], FIG. 6A shows a 900 L/min cyclone shown as cyclone 601. FIG. 6B shows a 1250 L/min cyclone, shown as cyclone 602. Cyclone 602 is configured for an aerosol sampling flow rate of 1250 L/min and a continuous liquid outflow rate of about 1 mL/min. As is clear from the figures, each cyclone 601 and cyclone 602 include an inlet section 606, a cyclone body 608, a liquid injection inlet 610, a vortex finder 612, a skimmer 614, a liquid outflow 616, and an air outlet 618.

The main difference between cyclones 601 and 602 is the inlet section. The shape of cyclone 602 is a constant width in the direction of airflow, while the depth narrows along a curve. Furthermore, the inlet section 606 of cyclone 602 also includes an atomizer 620 However, each cyclone 601 and cyclone 602 operates by a similar principle. Air enters the inlet section 606, and liquid enters the liquid injection inlet 610. The air and liquid mix as they enter the cyclone body 608 and begin swirling around the vortex finder 612. By the time the fluids reach the skimmer 614, the liquid clings to the walls of the cyclone body 608 and flows out via the liquid outflow 616. Air continues through to an air outlet 618.

Examples of traditional wet cyclone systems are shown in FIG. 6C and 6D, shown as cyclone 603 and cyclone 604. Cyclone 603, also called an “irrigated cyclone scrubber,” similarly includes an inlet section 606, allowing air to enter the cyclone body 608 and spiral downwards until changing directions to spiral upwards and out of the air outlet 618 on top. During its journey, the air mixes with liquid via an array of liquid injection inlets 610 within the chamber.

Cyclone 604 in FIG. 6D is also called a “cyclonic spray scrubber.” It includes an inlet section 606 on the bottom of the cyclone body 608, forcing air upwards. An array of liquid injection inlets 610, shown as a “spray manifold,” provides for liquid mixing. Cyclone 604 also includes straightening vanes 630 at the air outlet 618. [16]

An example commercial product of a cyclone-based system is shown in FIG. 6E as cyclone 605. Also shown in FIG. 6E is the functional flow diagram of the cyclone 605 [17].

An example of condensation-based systems includes condensation growth tube (CGT) devices, as shown in FIG. 6F, as system 680. System 680 collects a concentrated suspension of particles into a small liquid-filled vial. The system 680 uses a laminar flow tube with a wetted wick to form a region of supersaturated water vapor. A collection well gently heats the condensation-covered samples to evaporate the water [18].

### Example Method of Operation

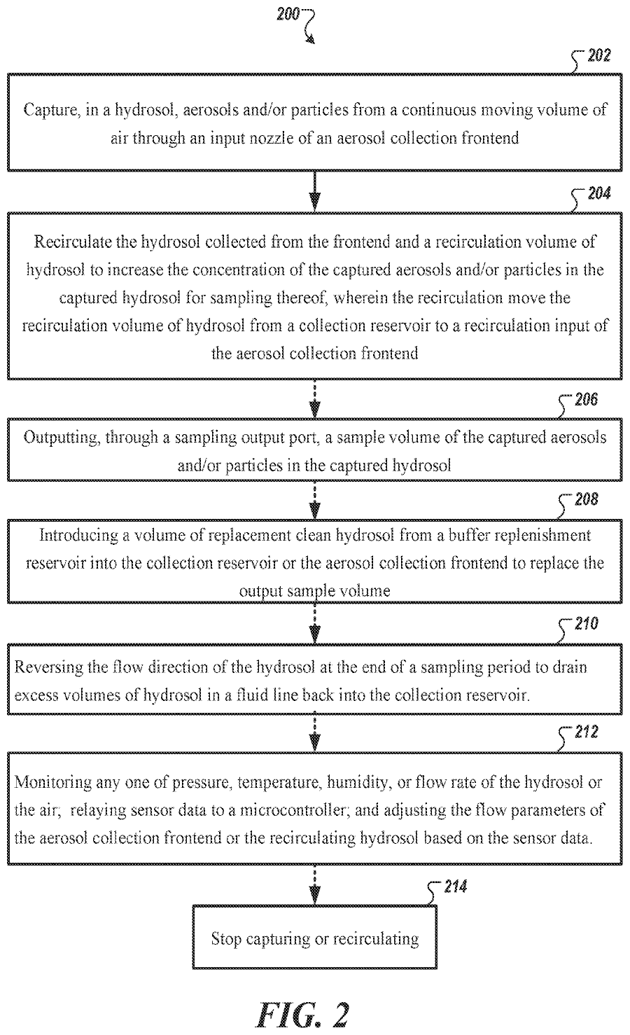

FIG. 2 is a flowchart showing an example method 200 to capture and amplify concentration in a hydrosol (e.g., buffer+captured aerosols and/or particles), aerosols and/or particles from a continuous moving volume of air (e.g., a continuous stream of air) in according to an illustrative embodiment.

Method 200 includes capturing (202), in a hydrosol (e.g., buffer+captured aerosols and/or particles), aerosols and/or particles from a continuous moving volume of air (e.g., a continuous stream of air) through an input nozzle of an aerosol collection frontend,

Method 200 further includes recirculating (204) the hydrosol collected from the frontend and a recirculation volume of hydrosol to increase the concentration of the captured aerosols and/or particles in the captured hydrosol for sampling thereof, wherein the recirculation moves the recirculation volume of hydrosol from a collection reservoir to a recirculation input of the aerosol collection frontend.

Method 200 further includes a number of optional steps for operation, denoted by a dotted-line arrow in the FIG. 2 flowchart. For example, the method 200 may include outputting (206), through a sampling output port, a sample volume of the captured aerosols and/or particles in the captured hydrosol. Furthermore, the method 200 may include introducing (208) a volume of replacement clean hydrosol from a buffer replenishment reservoir into the collection reservoir or the aerosol collection frontend to replace the output sample volume.

Method 200 may further include reversing (210) the flow direction of the hydrosol at the end of a sampling period to drain excess volumes of hydrosol in a fluid line back into the collection reservoir. Method 200 may further include monitoring (212) any one of pressure, temperature, humidity, or flow rate of the hydrosol or the air; relaying sensor data to a microcontroller; and adjusting the flow parameters of the aerosol collection frontend or the recirculating hydrosol based on the sensor data.

Finally, the method 200 includes a stopping step, wherein the recirculating or the capturing is stopped (214). In order to know when to stop, the method 200 may include a variety of predetermined parameters which signal one of the recirculating or the capturing to cease. For example, the method may stop capturing or recirculating when one of the following occurs: (i) a predetermined volume of the continuous moving volume of air has moved through the aerosol collection frontend; (ii) a predetermined period of time has passed since the capturing began; (iii) a predetermined period of time has passed since the recirculating began; (iv) a predetermined volume of the sample volume of the captured aerosols and/or particles in the captured hydrosol has been collected through the sampling output port; or (v) a predetermined volume of the replacement clean hydrosol has been introduced from the buffer replenishment reservoir into the collection reservoir or the aerosol collection frontend. In other implementations, a different signal or function may cease the operation of the recirculating or capturing steps. In other implementations, the stopping signal is a manual stop input by a user.

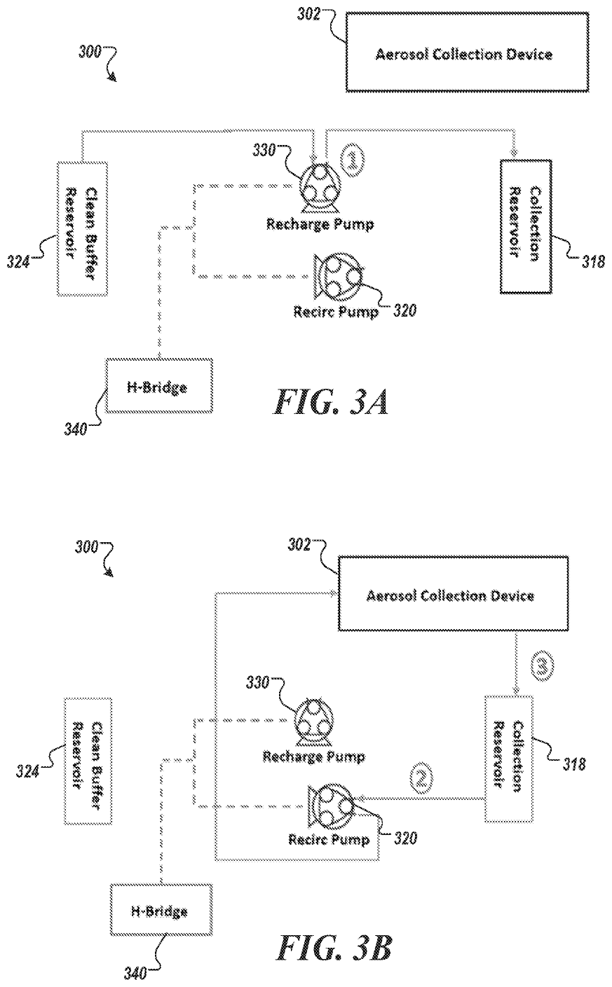

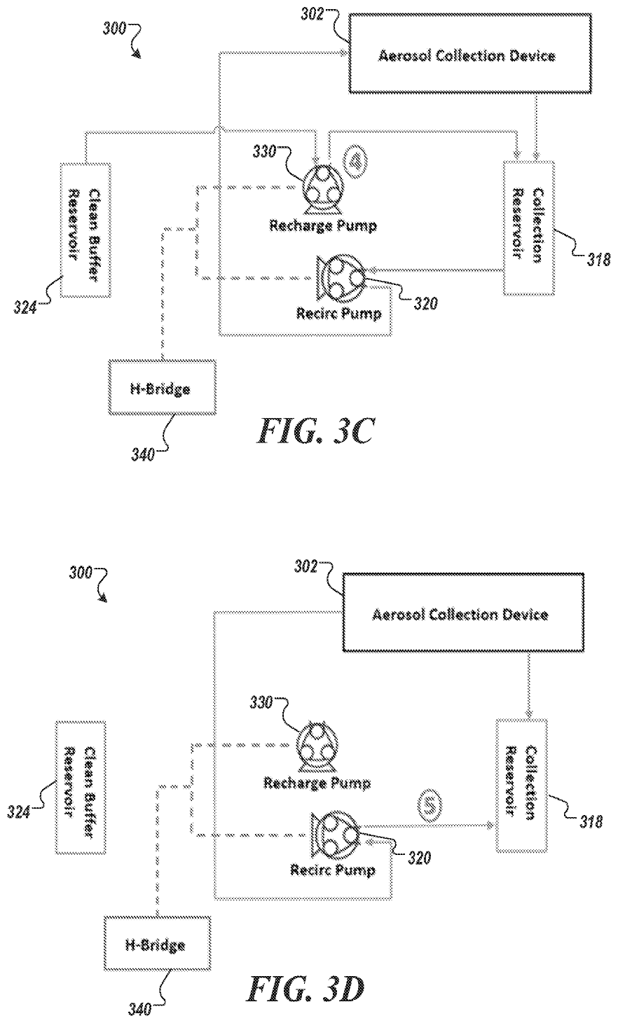

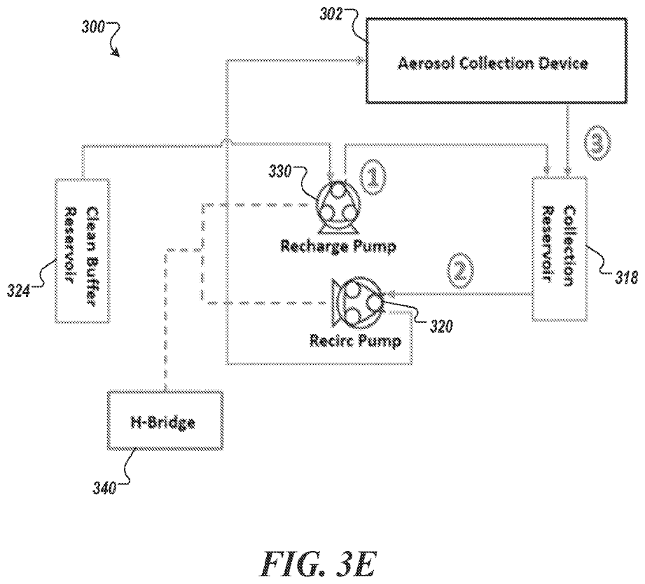

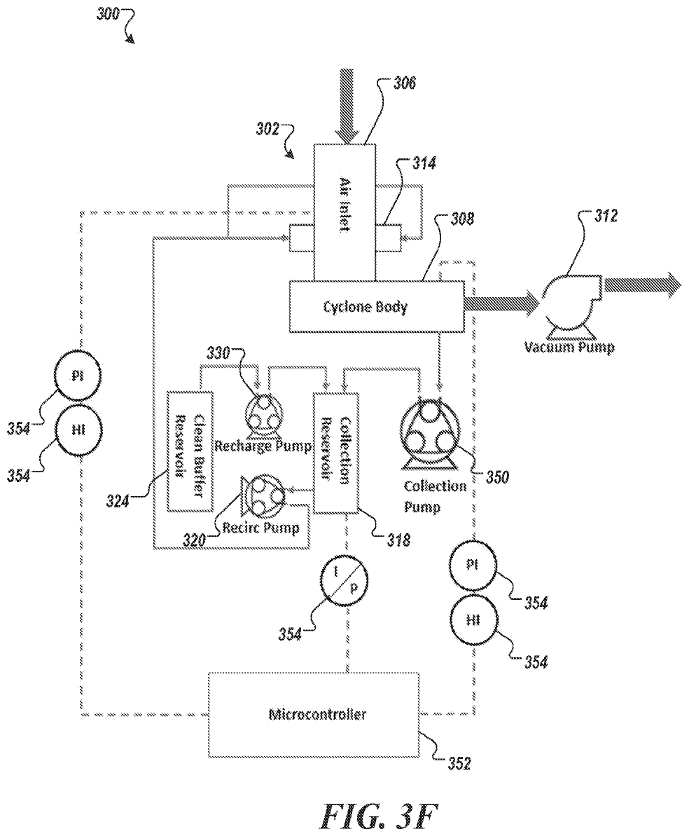

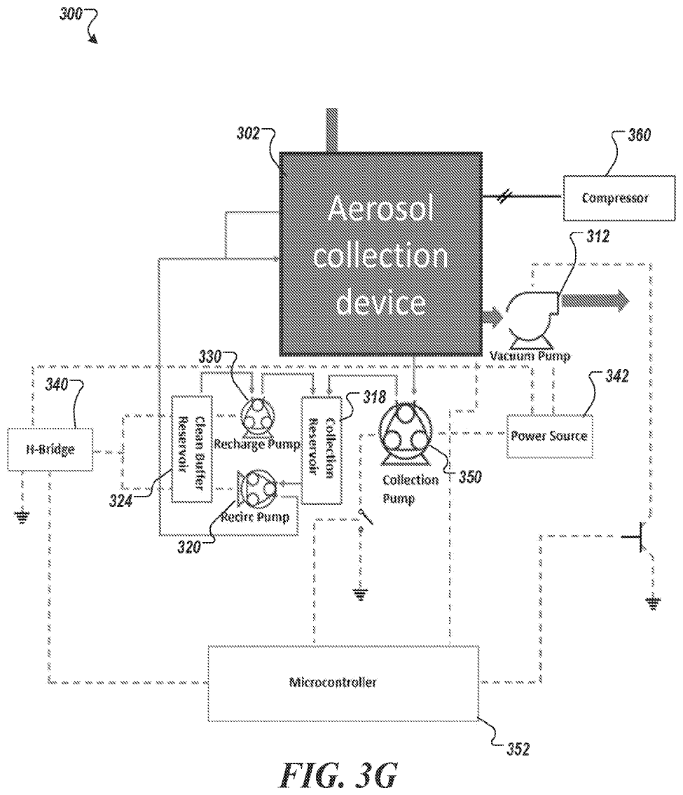

FIGS. 3A-3G show an example method of operation of an active recirculation system 300 for aerosol collectors. In FIG. 3A, at step “1”, the system 300 introduces a clean collection buffer from the clean buffer reservoir 324 into a collection reservoir 318 via a recharge pump 330 prior to the collection cycle. Also shown in system 300 is the H-bridge 340 configured to control the operation of each of recirculation pump 320 and recharge pump 330.

FIG. 3B shows the system 300, at step “2”, drawing the collection buffer from the collection reservoir 318 and pumping it into an aerosol collection device 302. After the aerosol collection device performs its functions, at step “3”, the hydrosol (buffer containing captured aerosols) enters the collection reservoir 318 for continued recirculation. Recirculation is motivated by the recirculation pump 320.

FIG. 3C shows the recharge pump 330 is turned on at step “4” to increase volume in collection reservoir 318 when it is determined that more collection buffer is needed in the system 300. The operation is performed without interruption to the recirculating system 300.

In FIG. 3D, at the end of the collection cycle, the system 300 can reverse the polarity of the recirculation pump 320 via the H-Bridge 340, shown as step “5”. The reversal is performed to draw fluids in the fluid lines connecting the aerosol collection device 302 to the pumps and reservoir(s) back into the collection reservoir 318.

The operation of FIGS. 3A and 3B are shown combined in FIG. 3E. In the example shown in FIG. 3E, in steps “2” and “3”, the collection buffer is continuously circulating through the system 300. Indeed, the exemplary system 300 can increase the concentration of the target particles in hydrosol by decreasing the fluid volume needed during the collection cycle. In addition, the system 300 can provide increased user control over fluid volume introduced during collection.

A more detailed diagram of the system 300 is shown in FIG. 3F. FIG. 3F expands on the aerosol collection device 302, showing the cyclone body 308, the air inlet 306, and the vacuum pump 312. Arrows adjacent to the air inlet 306 and vacuum pump 312 represent the air flow through the aerosol collection device 302. FIG. 3F also includes a mixer 314 with the recirculation inlet within which the air and fluid mix before entering the cyclone body 308.

FIG. 3F includes an additional collection pump 350 situated between the cyclone body 308 and the collection reservoir 318 to motivate the sample fluid into the recirculation loop. In other implementations, a number of pumps may be placed along the fluid flow lines where necessary.

FIG. 3F includes a microcontroller 352, which connects to sensors 354. The sensors 354 include pressure and humidity sensors 354 connected to the inlet and outlet of the aerosol collection device 302. The sensors 354 also include pressure and flow rate sensors connected to the collection reservoir 318. In other implementations, a variety of sensors may be placed at a variety of locations within the system 300 (e.g., pressure or flowrate sensors within the clean buffer reservoir, adjacent to the vacuum pump, or adjacent to the recharge pump).

FIG. 3G provides another detailed diagram showing the system 300 according to another implementation. In FIG. 3G, the aerosol collection device 302 has been generalized. A compressor 360 is included, connected to the aerosol collection device 102 to provide compressed air at the mixer/atomizer 314.

The electrical diagram in FIG. 3G is the most comprehensive, including both the microcontroller 352 and the H-bridge 340, which are in electrical communication with each other. Furthermore, a power source 342 is provided in electrical communication with the H-bridge 340, the vacuum pump 312, the collection pump 350, and the microcontroller 352. Overall, the electrical diagram of FIG. 3G shows the control and logic that is possible with system 300. Each of the pumps may be individually controlled in speed or direction, and the various pumps may be synchronized depending on the use case. Each of the sensors can provide data about the system 300, which may inform the operation of the various pumps.

### Example Wet Cyclone Aerosol Collection Frontend #2

Another example of a wet cyclone system is shown in FIGS. 4A-4D. The example wet cyclone system, shown as system 400, can be used for disease surveillance (e.g., COVID-19 surveillance or other bacterial/viral diseases transmitted through airborne biological particulates). The example system 400 may also be used for DNA forensics (e.g., human skin cells). Wetted wall cyclones can have flow rates of 1000 LPM, simultaneous particle collection and discharge, and comparatively low viability loss. However, wetted wall cyclones create high noise levels, may have many auxiliary devices, and have a detection limit of about 1 micrometer. Optimization of wetted wall cyclones includes fine-tuning of the geometrical parameters (e.g., inlet aspect ratio, body length, and vortex finder radius) and operational parameters (e.g., air and liquid flow rate).

A prototypical system 400 is shown in FIG. 4A, which operates similarly to the exemplary cyclone 602 of FIG. 6B. In addition to the physical prototype 400, FIG. 4A also shows a computer model of the aerosol collection system 400. The aerosol collection system 400 includes an air inlet 406. The air inlet 406 narrows towards the cylinder body 408. In the narrow section, the air inlet includes a recirculation input 416 and a mixer or atomizer 414. The recirculation input 406 introduces the fluid into the mixer 414 while the mixer 114 introduces pressurized air to atomize the fluid. The atomized fluid can then mix with and collect samples from the air flowing through. The air exits at air outlet 418, while the sample-laden fluid is collected by the skimmer 415 to exit at the fluid outlet 417.

FIG. 4B shows images of aerosol collection system 400 according to various physical implementations. For example, FIG. 4B includes an image with a housing 490.

FIG. 4C shows a computational fluid dynamics (CFD) graphic for a model aerosol collection system 400. As shown in the graphics, the fluid flow through the wet cyclone system creates a vortex that swirls around the cyclone axis 491.

The transportation mechanism for the buffer fluid is visible in FIG. 4B by the formation of “rivulets” 494 on the inner surface of the cyclone body (detail added for visibility). These rivulets 494 follow the vortex flow path visible in FIG. 4C. The rivulets 494 provide for fluid transport from a side of the recirculation inlet 406 of the cyclone body to the skimmer 415 and fluid outlet 417. The rivulets 494 forms at an angle with respect to a plane orthogonal to the cyclone axis 491, and they are affected by a variety of geometrical and flow parameters (air flow rate, tube diameter, etc.).

FIG. 4D shows experimental results for tests performed on aerosol collection system 400. Tests were performed with variations in liquid flow rate (2.5, 5, 7.5, 10, and 12.5 mL/min) and variations in vacuum flow rate (970, 1210, 1440, 1690 L/min). Fluid recovery rates were calculated for each combination of liquid flow rate and vacuum flow rate, as shown in the graphs in FIG. 4D. The experimental results imply that an excessive air flow rate decreases the fluid recovery possibly due to the enhanced turbulence while the liquid flow rate above 5 mL/min achieves higher fluid recovery. In conclusion, this study found air flow rate of ˜1000 L/min and liquid flow rate of >5 mL/min is the optimal combination to enable a high fluid recovery above 80%.

### Experimental Results and Examples

A study was conducted to develop and build a bioaerosol collection and analysis system that can be placed and run within an HVAC system (return air side) of a large residential or commercial. In one scenario, the study evaluated the bioaerosol collection and analysis system in relation to a ten-story building to detect concentrations of SARS-COV-2 of 1 particle, or 1 plaque-forming unit (pfu) per liter (L) of air and alert within 15 minutes (threshold metrics). The study had objective metrics of 0.1 pfu/L with an alert in 5 minutes. The system has the benefits to provide near real-time warning to military personnel of an infectious environment so that protective measures can be implemented to prevent disease. The sensor has a selectivity for SARS-COV-2 that is a function of the specificity of the bioreceptor. Thus, by switching out the biosensor, this technology has extensibility to any other pathogen for which a bioreceptor exists. This technology can be scaled down or up in size, weight, and power (SWaP) and be portable or used in smaller or larger buildings, auditoriums, and conference rooms or as stand-off sensors for perimeter protection or even flown from unmanned aerial vehicles (UAVs) for use on the battlefield.

The bioaerosol collector system included a wet-walled cyclone (FIG. 4) that is configured to use a phosphate-buffered saline (PBS) solution as a hydrosol (as a collection fluid) that is atomized into the collection air flow of approximately 1,750 L/min. The wet-walled cyclone includes an air inlet 110 (shown as 110′), liquid atomizer, skimmer, aspiration port, and air outlet. A recirculation mode is activated where the collected hydrosol is channeled back to the atomizers at a time point after collection begins. This has two advantages: 1) using less reagent per collection run reduces system size and weight, and 2) enriching the target concentration in the collected hydrosol. A typical run with the latest design results in a total collected volume of between 10 mL and 1 mL, depending on ambient conditions. The achieved collection efficiency using fluorescent polystyrene latex (PSL) beads in the respirable particle size range was a maximum of ˜70% for particle sizes of 2 to 6 microns (particle diameter) with lower efficiencies at the 1 and 10-micron sizes.

The fluidics system filters the collected hydrosol for particles larger than 10 microns (environmental debris, pollens, etc.) and concentrates the target organism through volume reduction with target retention. Currently, this is achieved using tangential flow filtration (TFF) and influenza virus (H1N1-WSN-33) as a surrogate. This has achieved significant volume reduction (10 mL down to 250 μL) and concentration increase by a factor of about 2×. The fluidics system then delivers the sample to the sensor for analysis.

In the study, the prototyped system was configured to perform bioaerosol collection at an airflow of 18,000 to 20,000 L/min. The system could process and collect at a fluid (hydrosol) flow rate of at least 5 mL/min at a collection efficiency of ˜65% for particles 2-6 μm in diameter and reduce the total collection volume to 10-12 mL. Fluidics system can efficiently remove unwanted large environmental particulate >5 to 10 μm in diameter while retaining nearly all target viruses. The fluidics system can reduce collection volume from 10 mL to 250 μL and increase the concentration of the target by 2-fold. Table 1 shows the performance metrics for the study.

TABLE 1

| Technology component | Performance Metric Description | Current Status |
|---|---|---|
| Bioaerosol collector | Particle collection efficiency | ~65% |
| | Hydrosol flow rate | <5 mL/min |
| | Concentration of target | ~7.5-fold |
| Fluidics module | Target concentration | ~1.6-fold |
| | Target purification | Untested |

Bioaerosol Collector. The bioaerosol collector included a wet-walled cyclone that used a phosphate-buffered saline (PBS) solution as the hydrosol (collection fluid) that was atomized into the collection air flow at approximately 1,750 L/min. The collection device was configured with the exemplary recirculation mode to channel the collected hydrosol to the wet- walled cyclone.

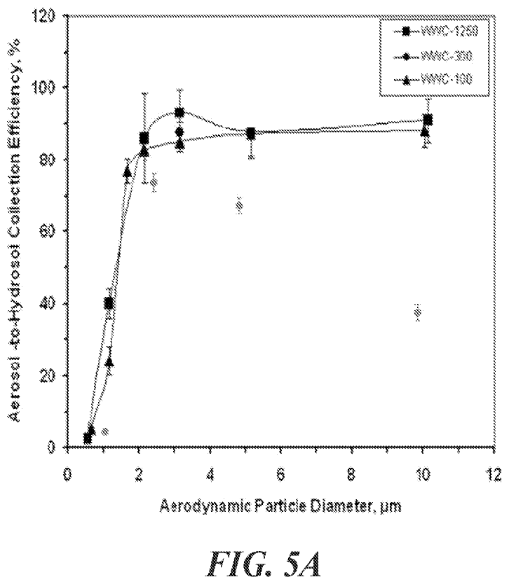

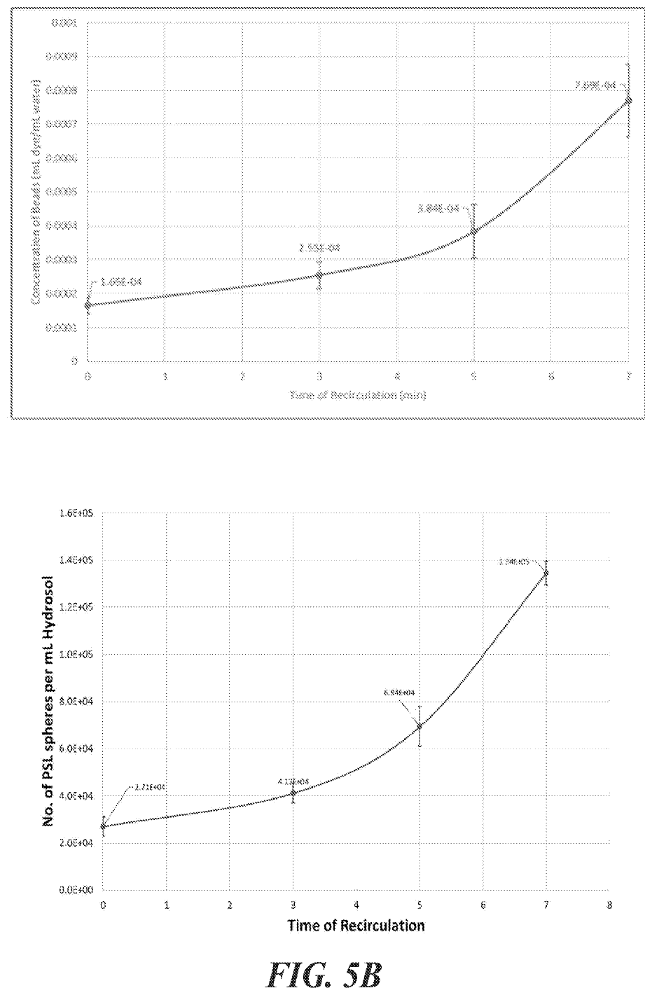

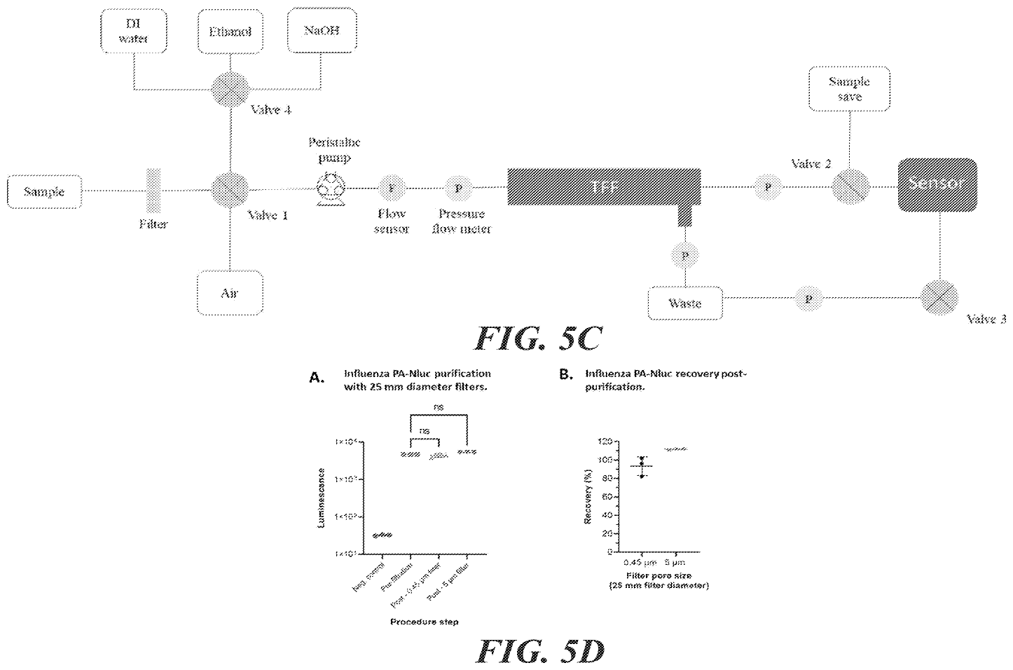

The study established the collection efficiency of the cyclone for various-sized PSL fluorescent beads within the respirable range of concern [1]. The data showed a general trend in efficiency that approaches values seen in the Mcfarland cyclone [2]. FIG. 5A shows the measured efficiency for the SenSARS collector (red) on a plot showing McFarland's data. For 2.3-and 4.8-micron PSL beads, the SenSARS cyclone showed a collection efficiency of 73.2% and 67.5% (respectively). Using these data points as a guide, the study estimated the current collection efficiency for the SenSARS cyclone to be roughly 70% for particle sizes 2 microns and above.

With the implementation of the exemplary recirculation system, the study observed an increase in the concentration of target particles collected by introducing clean collection fluid for the first 3 minutes of a collection cycle and then continually recirculating that collection fluid for the remaining 7 minutes of the 10-minute collection cycle. By recirculating the hydrosol, the study was able to reduce the amount of fluid delivered to the fluidics module to less than 10 mL, which would be roughly 40 mL without recirculation. By reducing the amount of fluid delivered without sacrificing collection efficiency, the concentration of target particles per mL of fluid increases by about 5-fold. FIG. 5B shows the measured number of PSL beads collected at varying recirculation times. FIG. 5B also shows the same measured PSL beads collected by measured concentration at varying recirculation times. It was observed that the increased concentration of the fluorescent PSL beads in the hydrosol solution as the time of recirculation increased. As the plot shows, even at a recirculation time of 7 minutes for a 10-minute trial, the number of PSL beads collected has not reached a maximum. This suggests that by re-atomizing the hydrosol, there is negligible loss of particles that have already been collected in the system.

The SenSARS collection cyclone operated at an airflow rate between 1,800 and 2,400 LPM (depending on test conditions), which is higher than originally estimated. At this higher flow rate, the system had a total of 20,000 Liters of air moving through the cyclone for each 10-minute collection cycle. By applying current performance measurements of the cyclone to Equation 1, the study estimated that the concentration of target particles in the solution delivered to the fluidics module to be 1,550 pfu per mL of fluid collected. And by physically decreasing the distance between the recirculation pump and the atomizer, the volume of hydrosol in the fluid lines can be reduced during recirculation from 9 mL to 5 mL to provide a concentration of 2,000 pfu/mL. Equation 1 provides the calculation for the concentration of the target:

$$Concentration of target = \frac{{V}_{air} * {C}_{ambient} * η}{{V}_{hydrosol}} \qquad ( Eq . 1 )$$

where Vₐᵢᵣ is the amount of air passed through the aerosol collection frontend for a single collection cycle, C_{ambient} is the concentration of particles in ambient air, η is the particle collection efficiency, and V_{hydrosol} is the total volume of hydrosol collected at the end of the collection cycle.

The fluidics system filters the collected hydrosol to remove particles larger than 10 microns (environmental debris, pollens, etc.) and concentrates the target organism through volume reduction with target retention, then delivers the sample to the sensor. FIG. 5C shows a diagram of the fluidic system. The study characterized the effectiveness of the purification and concentration steps using influenza as the virus surrogate and fluorescent polystyrene beads (Fisher Scientific) as the interferents. The efficiency of the purification step was tested using a 0.45 μm and a 5 μm hydrophilic polyvinylidene fluoride (PVDF) syringe filter using the enzyme tagged (PA-NLuc) influenza (H1N1 A/WSN/33) stock. For quantification of the virus before and after passing through the fluidics module, the study used the Nano-Glo Luciferase Assay (Promega) comprising a mock sample containing influenza virus at 2×10⁶ pfu/mL and 2 and 10 μm fluorescent PSL beads (Fisher Scientific) at 1×10⁶ beads/mL each. The bead concentration mimicked a high concentration of interfering aerosol particles that might be found in an environment [3]. The study used the Nano-Glo Luciferase Assay to analyze the recovery of the virus and flow cytometry and fluorescent microscopy to analyze the removal of the beads. The recovery of the virus was defined as shown in the Equation 2. The relationship between the luminescence and the concentration of the virus was within the linear range of the assay, so the luminescence value was used as the concentration value for our calculations.

$$Recovery = \frac{{Concentration}_{Post - filtration} \times {Volume}_{Post - filtration}}{{Concentration}_{Pre - filtration} \times {Volume}_{Pre - filtration}} \qquad ( Eq . 2 )$$

The results in FIG. 5D, subpanel (A) show that there were no statistically significant differences in the sample luminescence between the pre-filtration and post-filtration samples. This demonstrated that the virus could be fully recovered through this filtration step, as shown in FIG. 5D, subpanel (B). The results show a successful recovery of the virus and the removal of interferents with the purification method.

### Discussion

A wetted wall aerosol sampling cyclone is similar to the instant system. An example wetted wall aerosol sampling cyclone system is described in U.S. Patent Application Publication No. 2009/0193971 A1. That system does not continuously recirculate the collection fluid.

Another similar design includes a subsystem of the SAS2300 Wetted Wall Air Sampler (U.S. Pat. No. 6,532,835 B1) that passively recycles collection liquid through an aerosol collector. Though there are similarities, the exemplary system at least additionally provides for the control of the final fluid volume via the use of pumps to control liquid volume levels.

### Conclusion

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

As discussed herein, a “subject” may be any applicable human, animal, or another organism, living or dead, or other biological or molecular structure or chemical environment, and may relate to particular components of the subject, for instance, specific tissues or fluids of a subject (e.g., human tissue in a particular area of the body of a living subject), which may be in a particular location of the subject, referred to herein as an “area of interest” or a “region of interest.”

It should be appreciated that, as discussed herein, a subject may be a human or any animal. It should be appreciated that an animal may be a variety of any applicable type, including, but not limited thereto, mammal, veterinarian animal, livestock animal or pet type animal, etc. As an example, the animal may be a laboratory animal specifically selected to have certain characteristics similar to humans (e.g., rat, dog, pig, monkey), etc. It should be appreciated that the subject may be any applicable human patient, for example.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1,5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

All references cited and discussed in this specification are incorporated herein by reference in their entireties and to the same extent as if each reference was individually incorporated by reference.

### REFERENCES

[1] McFarland, A. R., et al., 2020. Wetted Wall Cyclones for Bioaerosol Sampling. Aerosol Science and Technology. 44:241-252. https://www.tandfonline.com/doi/full/10.1080/02786820903555552
[2] Fennely, K. P., 2020. Particle sizes of infections aerosols: implications for infection control. The Lancet. 8:914-924. https://www.thelancet.com/journals/lanres/article/PIIS2213-2600(20)30323-4/fulltext
[3] Seinfeld, J. H., & Pandis, S. N. (2016). Atmospheric Chemistry and Physics: From Air Pollution to Climate Change. 3^{rd} Edition, John Wiley & Sons, Hoboken, NJ.
[4] Lam, K. S., et al., 1991. A new type of synthetic peptide library for identifying ligand-binding activity. Nature. 354:82-84. https://www.nature.com/articles/354082a0
[5] Agnew, H. D., et al., 2019. Protein-Catalyzed Capture Agents, Chem. Rev. 119:9950-9970. https://pubs.acs.org/doi/10.1021/acs.chemrev.8b00660
[6] Lewis, W. G., et al., 2002. Click chemistry in situ: Acetylcholinesterase as a reaction vessel for the selective assembly of a femtomolar inhibitor from an array of building blocks. Angew. Chemie-Int. Ed. 114:1095-1099. https://pubmed.ncbi.nlm.nih.gov/12491310/
[7] Coppock, M. B., et al., 2017. Protein catalyzed capture agents with tailored performance for in vitro and in vivo applications. Pept. Sci. 108:e22934. https://pubmed.ncbi.nlm.nih.gov/27539157/
[8] Coppock, M. B., et al., 2019. A universal method for the functionalization of dyed magnetic microspheres with peptides. Methods. 158:12-16. https://www.sciencedirect.com/science/article/pii/S1046202318302056
[9] Coppock, M. B., et al., 2019. A novel discovery, maturation, and assay integration approach for the development of ruggedized multi-valent capture receptors exemplified against the chikungunya virus E2 protein. Sens. Bio-Sensing Res. 22:100248. https://www.sciencedirect.com/science/article/pii/S2214180418300692
[10] Chapman, A. P., Tang, X., Lee, J. R. et al. Rapid development of neutralizing and diagnostic SARS-COV-2 mouse monoclonal antibodies. Sci Rep 11, 9682 (2021). https://doi.org/10.1038/s41598-021-88809-0.
[11] Sino Biological product sheet, https://cdn1.sinobiological.com/reagent/40150-R007.pdf
[12] Sino Biological product sheet, https://cdn1.sinobiological.com/reagent/40589-T62.pdf
[13] Biotechnologies, B. White Paper—Aptamers to SARS-COV-2 (COVID-19) spike protein for use in a variety of customer assay platforms. https://www.basepairbio.com/covid19/.
[14] Goldsmith, B. R., et al., 2019. Digital Biosensing by Foundry-Fabricated Graphene Sensors. Sci Rep. 9:1-10. https://www.nature.com/articles/s41598-019-38700-w
[15] Hajian, R., et al., 2019 Detection of unamplified target genes via CRISPR-Cas9 immobilized on a graphene field-effect transistor. Nature Biomedical Engineering. doi: 10.1038/s41551-019-0371-x. https://www.nature.com/articles/s41551-019-0371-x.
[16] Wikimedia Foundation. (2021 August 3). Cyclonic spray scrubber. Wikipedia. Retrieved February 6, 2023, from https://en.wikipedia.org/wiki/Cyclonic_spray_scrubber
[17] SASS® 2400. SASS 2400 Low-Volume Wet Air Sampler|CBRN International. (n.d.). Retrieved February 6, 2023, from https://cbmintl.com/SASS_2400_air_sampler.html
[18] Liquid spot sampler. Aerosol Devices. (2021 January 15). Retrieved February 6, 2023, from https://aerosoldevices.com/products/liquid-spot-sampler/

1. A system comprising:
an aerosol collection frontend configured to capture, in a hydrosol, aerosols and/or particles from a continuous moving volume of air through an input nozzle; and
a recirculation assembly operatively coupled to the aerosol collection frontend to recirculate the hydrosol collected from the aerosol collection frontend and a recirculation volume of hydrosol to increase a concentration of the captured aerosols and/or particles in the captured hydrosol for sampling thereof, the recirculation assembly comprising:
a collection reservoir configured to connect to the aerosol collection frontend to collect the hydrosol, the collection reservoir maintaining a part of the recirculation volume of hydrosol, and
a first pump operatively connected to the collection reservoir to move the recirculation volume of hydrosol from the collection reservoir to a recirculation input of the aerosol collection frontend.

2. The system of claim 1, further comprising:
a buffer replenishment reservoir; and
a second pump operatively connected to the buffer replenishment reservoir to move replacement clean hydrosol from the buffer replenishment reservoir to the collection reservoir.

3. The system of claim 1 further comprising a filter, wherein the aerosols and/or particles is less than 10 μm.

4. The system of claim 1, further comprising:
a sampling output port or sensor for analysis of the captured aerosols and/or particles in the captured hydrosol.

5. The system of claim 4, further comprising:
a sensor module coupled to the sampling output port or sensor, wherein the sensor module is configured to analyze the captured aerosols and/or particles in the captured hydrosol to detect a target pathogen or particle.

6. The system of claim 5, wherein the sensor module is modular such that the sensor module may be replaced with a different sensor module configured to analyze and detect a different target pathogen or particle.

7. The system of claim 1, wherein the aerosol collection frontend comprises a wet cyclone assembly, a wetted wall cyclone assembly, or a condensation-based collection assembly.

8. The system of claim 7, wherein the wet cyclone assembly or the wetted wall cyclone assembly comprises:
a fluid atomizer or a mixer configured to mix the hydrosol with the continuous moving volume of air; and
a skimmer configured to collect the captured hydrosol and guide it towards the recirculation assembly.

9. The system of claim 1, wherein the hydrosol comprises a buffered saline solution.

10. The system of claim 1, further comprising:
an H-bridge converter to operate the first pump of the recirculation assembly.

11. The system of claim 1, wherein the system is configured to provide airflow of at least 18,000 L/min with a collection efficiency greater than 65%, and a concentration increase of at least 2×.

12. The system of claim 2, further comprising:
a plurality of sensors connected to at least one of the aerosol collection frontend, the collection reservoir, the buffer replenishment reservoir, or any fluid conduit therebetween,
wherein any one of the plurality of sensors is configured to sense pressure, humidity, temperature, or flowrate.

13. The system of claim 12, further comprising:
a microcontroller in electrical communication with the plurality of sensors, the microcontroller configured to communicate with an H-bridge to control convertor to control operation of the first pump or the second pump.

14. A method of capturing aerosols and/or particles from a continuous moving volume of air, the method comprising:
capturing, in a hydrosol, aerosols and/or particles from a continuous moving volume of air through an input nozzle of an aerosol collection frontend; and
recirculating the hydrosol collected from the aerosol collection frontend and a recirculation volume of hydrosol to increase the concentration of the captured aerosols and/or particles in the captured hydrosol for sampling thereof, wherein the recirculating moves the recirculation volume of hydrosol from a collection reservoir to a recirculation input of the aerosol collection frontend.

15. The method of claim 14, further comprising:
outputting, through a sampling output port, a sample volume of the captured aerosols and/or particles in the captured hydrosol.

16. The method of claim 15, further comprising:
introducing a volume of replacement clean hydrosol from a buffer replenishment reservoir into the collection reservoir or the aerosol collection frontend to replace the output sample volume.

17. The method of claim 16, further comprising:
reversing the flow direction of the hydrosol at the end of a sampling period to drain excess volumes of hydrosol in a fluid line back into the collection reservoir.

18. The method of claim 17, further comprising:
monitoring any one of pressure, temperature, humidity, or flow rate of the hydrosol or the air
relaying sensor data to a microcontroller; and
adjusting the flow parameters of the aerosol collection frontend or the recirculating hydrosol based on the sensor data.

19. The method of claim 14,
wherein the capturing or recirculating steps are performed until:
(i) a predetermined volume of the continuous moving volume of air has moved through the aerosol collection frontend;
(ii) a predetermined period of time has passed since the capturing began;
(iii) a predetermined period of time has passed since the recirculating began;
(iv) a predetermined volume of the sample volume of the captured aerosols and/or particles in the captured hydrosol has been collected through the sampling output port; or
(v) a predetermined volume of the replacement clean hydrosol has been introduced from the buffer replenishment reservoir into the collection reservoir or the aerosol collection frontend.

20. The method of claim 14, further comprising:
analyzing a sample volume of the captured aerosols and/or particles in the captured hydrosol; and
detecting the presence or absence of a target pathogen or particle.
